(19) United States
(12) Patent Application Publication
(10) Pub. No.: US 2014/0014849 A1
(43) Pub. Date: Jan. 16, 2014

(54) Permanent Magnet Beam Transport System for Proton Radiation Therapy

(71) Applicants: Vladimir A. Anferov, Bloomington, IN (US); John M. Cameron, Bloomington, IN (US); James T. Volk, Batavia, IL (US)

(72) Inventors: Vladimir A. Anferov, Bloomington, IN (US); John M. Cameron, Bloomington, IN (US); James T. Volk, Batavia, IL (US)

(73) Assignee: ProCure Treatment Centers, Inc., Bloomington, IN (US)

(21) Appl. No.: 13/936,859

(22) Filed: Jul. 8, 2013

Related U.S. Application Data
(60) Provisional application No. 61/670,225, filed on Jul. 11, 2012.

(51) Int. Cl. H01J 3/26

(52) U.S. Cl. CPC H01J 3/26
USPC 250/396 R

(57) ABSTRACT

A particle beam transport system used for particle radiation therapy is provided. A beam of particles exiting from an accelerator is transported at fixed energy for treatment of patients in one or more treatment rooms using permanent magnets. In one embodiment, the system includes a series of fixed-magnetic-field permanent magnets as beam focusing elements that transport the beam at fixed energy to a point where the constant energy beam can be modified for use independently in different treatment rooms. In some embodiments, the particle beam may be deflected using dipole or Lambertson magnets manufactured using permanent magnetic material. The system may also incorporate a matching section imposed as the beam exits the accelerator. The matching system includes diagnostic elements and feedback systems that verify the beam properties as it exits the accelerator, and modify it, if necessary, until the beam attains a desired energy value.

### CROSS REFERENCE TO RELATED APPLICATIONS

This patent application claims the benefit of U.S. Provisional Patent Application No. 61/670,225, filed Jul. 11, 2012, the entire teachings and disclosure of which are incorporated herein by reference thereto.

### FIELD OF THE INVENTION

The present invention generally relates to particle radiation therapy, and more specifically, the present invention relates to application of beam lines that use permanent magnet to transport and guide fixed energy particle beams used to treat patients in particle radiation therapy facilities.

### BACKGROUND OF THE INVENTION

Over half of all cancer patients in the U.S. are treated with radiation therapy. Radiation therapy is based on irradiating the patient, more particularly his or her tumor, with ionizing radiation. Of these patients, the number which are being treated with particle therapy worldwide is increasing rapidly. In the particular case of proton radiation therapy, the radiation is performed using a proton beam. It is the dose of radiation delivered to the tumor which is responsible for its destruction. Proton therapy is a desired form of radiation therapy because, in comparison to standard x-ray radiation therapy, proton therapy allows an increased dose of radiation to a tumor while reducing the amount of radiation to the healthy tissue surrounding it, as shown in FIG. 1.

The central challenge to modern radiation therapy is to enhance local tumor control using dose escalation, and to minimize the dose to normal tissues in order to improve survival and the quality of life of the patients. Radiation can damage normal tissue and thus causes both short-term and later-stage tumors in long-term cancer survivors.

The recent progress made by 3D conformal and intensity-modulated radiation therapy has reduced short-term radiation-induced complications, especially in dose-limiting organs like the brain, lung, and intestine. Yet, acute short-term complications do occur and are still the limiting factor for some treatments. More insidious for younger patients is the long-term potential occurrence of secondary tumors for years and even decades after the treatment.

The replacement of x-ray therapy with protons could have substantial long-term benefit to patients due to greatly reduced long- and short-term toxicity side effects. Such effects also have substantial costs associated with their treatment, which may continue for many years after the initial radiation therapy. If the cost of proton therapy treatment can be made about equivalent to that of x-rays for the primary treatment, the use of protons would likely result in substantial long-term savings to patients and healthcare providers.

One of the major roadblocks to the greater application of proton therapy is that of cost. The high capital cost of a proton therapy center is due to both the cost of the complex proton-beam-generating equipment, and of the heavily shielded vaults in which it is installed. Further, because of the need to adjust the magnet operating parameters to transport different particle energy beams, conventional beam transport lines currently used in proton therapy facilities are comprised primarily of large electromagnets and an evacuated pipe. Typically, these electromagnets require high current power supplies and installation of water cooling and various control systems. Such a beam transport line is shown in FIG. 2. Variation in the power supply voltage, supply current, or cavitation in the cooling water system can cause the beam to move, thereby reducing the effectiveness of the treatment. Typical quadrupole magnets used in conventional proton therapy system beam lines weigh over 1,000 lbs.

To increase the use of these proton therapy systems, the cost of building and operating these systems must be reduced. Further, there is a need to be able to fit proton therapy centers into existing buildings or into structures where space is severely limited, such as in inner city sites or at existing treatment centers. In such cases, the particle beam system layout may need to take many different configurations and/or orientations.

In view of the above, it is evident that there is a need in the art for a more cost-effective beam transport line concept that does not require expensive and complex control of large electromagnetic magnets in a proton therapy treatment center.

Embodiments of the invention provide a system that addresses some of the above-described problems. These and other advantages of the invention, as well as additional inventive features, will be apparent from the description of the invention provided herein.

### BRIEF SUMMARY OF THE INVENTION

In one aspect, embodiments of the invention provide a particle beam transport system in which separate energy beam modification systems are installed at the entry to each treatment room. In this embodiment, the beam transported in the main beam transfer line is of fixed energy and thus fixed-magnetic-field-strength permanent magnets may be used.

In embodiments of the present invention, permanent magnets are used to transport a fixed energy beam for use in all treatment rooms, thus reducing the complexity and cost of magnet installation as it requires no electrical power or water. Light weight, low cost, and absence of utilities in permanent magnet beam lines enable compact non planar facility arrangements, where accelerator can be placed at the basement level, reducing the total facility footprint and the need for shielding.

In particular embodiments, the use of permanent magnets allows prefabrication of unit sections of the beam transport system to be completed at the manufacturing site. Further, the use of permanent magnets in embodiments of the present invention greatly reduces the operating cost of the beam transport system.

In another aspect, embodiments of the invention provide a particle beam transport system for use in treating a patient by means of particle radiation therapy wherein a beam of particles exiting from an accelerator is transported at fixed energy in arbitrary direction using a system of fixed-magnetic-field permanent magnets. In particular embodiments, the permanent magnets provide high magnetic field strength by use of rare earth elements. In other embodiments, the constant energy beam is directed independently using a permanent magnet Lambertson for treatment of patients in one or more treatment rooms.

In certain embodiments, a matching section is imposed as the beam exits the particle accelerator, the matching system having diagnostic elements and feedback control systems that evaluate the beam energy exiting the accelerator and if necessary automatically modifies its properties until it attains some pre-specified energy and direction. The matching section may include variable-magnetic-field dipole and quadrupole electro-magnets. In certain embodiment, the matching section automatically varies and directs the beam along a line on which permanent quadrupole magnets are positioned.

In more particular embodiment, the particle beam transport system includes one or more permanent magnet quadrupole magnets. In alternate embodiments, the particle beam transport system includes one or more permanent dipole magnets. In some embodiments, the particle beam transport system includes one or more permanent magnets Lambertson.

In some embodiments, an array of permanent magnets is arranged in various configurations to transport the beam in various directions to fit into an existing space or where space is limited. The particle beam transport system may include one or more ambient temperature electro-magnets in addition to permanent magnets. Furthermore, the permanent magnets may be made from a strontium ferrite material. Alternatively, the permanent magnets may be made from samarium cobalt, and, collectively, weigh less than 300 lbs. In a particular embodiment, several permanent magnets are mounted on stands and aligned on a common mechanical device before installation.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention.

FIG. 1 is a graphical illustration showing a depth dose comparison for X-ray and proton radiation therapy;

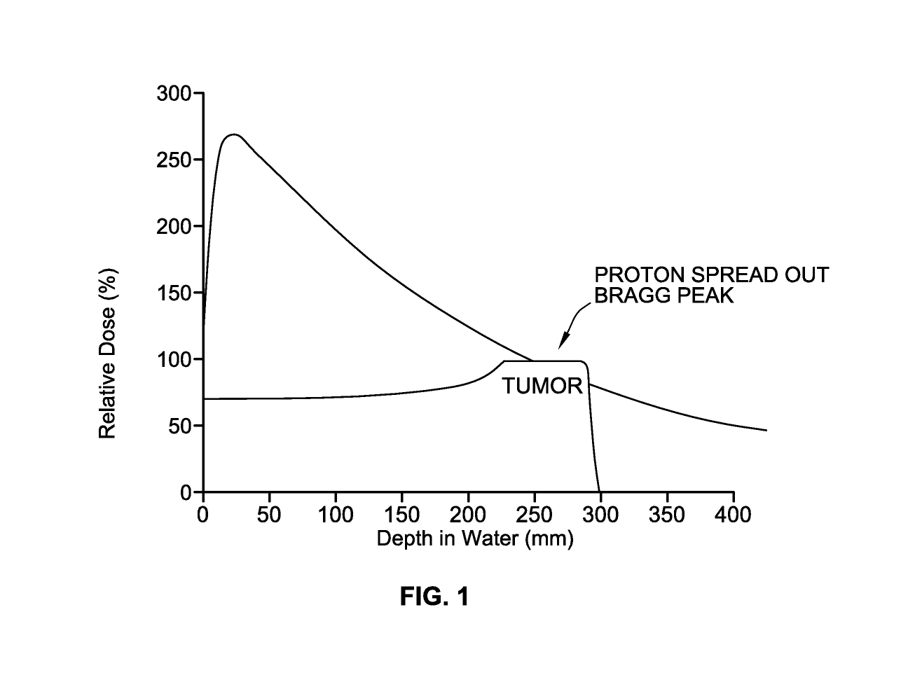

FIG. 2 is a top view showing a conventional particle beam modification and transport system known in the prior art;

FIG. 3 is a top view of a particle beam transport system that uses fixed-magnetic-field-strength permanent magnets for beam transport, constructed in accordance with an embodiment of the invention;

FIG. 4 is a plan view of a beam line using permanent magnets preassembled onto a stand, according to an embodiment of the invention;

FIG. 5 is a top view of a particle beam transport system, different from that of FIG. 3, that uses fixed-magnetic-field-strength permanent magnets for beam transport, constructed in accordance with an embodiment of the invention; and

FIG. 6 is a side view of a Lambertson magnet and associated magnetic field, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

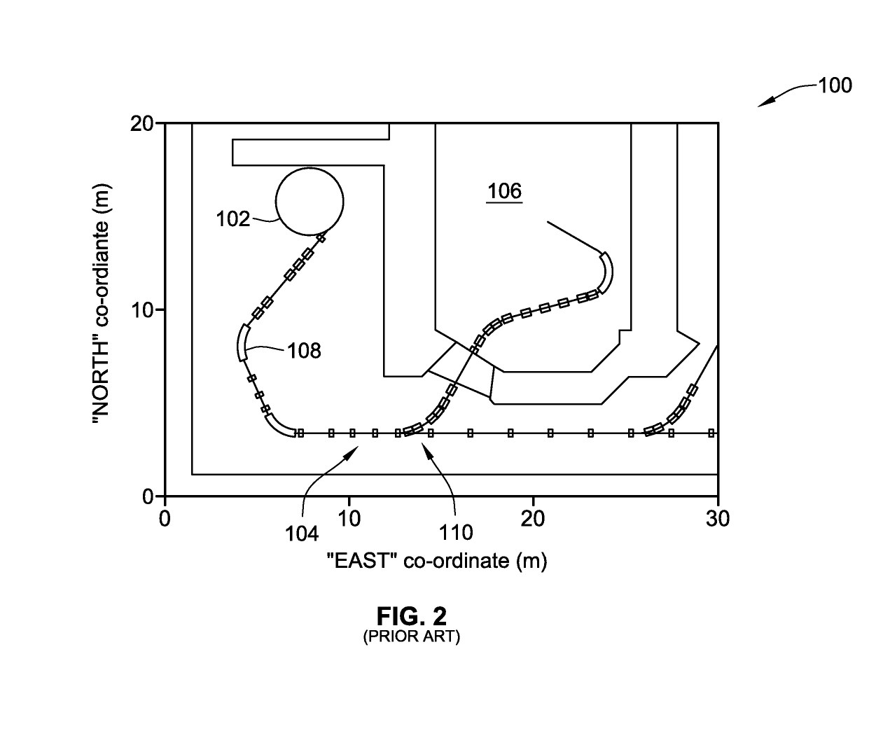

FIG. 2 is a top view showing a conventional particle beam modification and transport system 100 wherein the beam energy is modified and selected immediately after exiting from the accelerator 102 and then transported in a main transport line 104 at various energies to where it is required for treatment in any of a series of treatment rooms 106. In the transport system 100, the beam exiting the accelerator 102 at a fixed energy is degraded in energy, and then a specific energy is selected in an energy selection system. Such a beam modification and transport system 100 requires that the current in the magnets 108 of the main beam transport line 104 be varied for each of the different proton beam energies required for a treatment procedure in any of the treatment rooms 106, a difficult and time-consuming hands-on process.

For example, in most proton therapy facilities, the various particle beam energies required to irradiate a tumor volume are obtained directly from the particle accelerator 102 (synchrotrons), or by modifying the beam energy immediately after it exits from the accelerator 102 (cyclotrons). In either case it is necessary to transport beams of different energies to where they are deflected in a variety of treatment rooms using a series of large, heavy electromagnets 110.

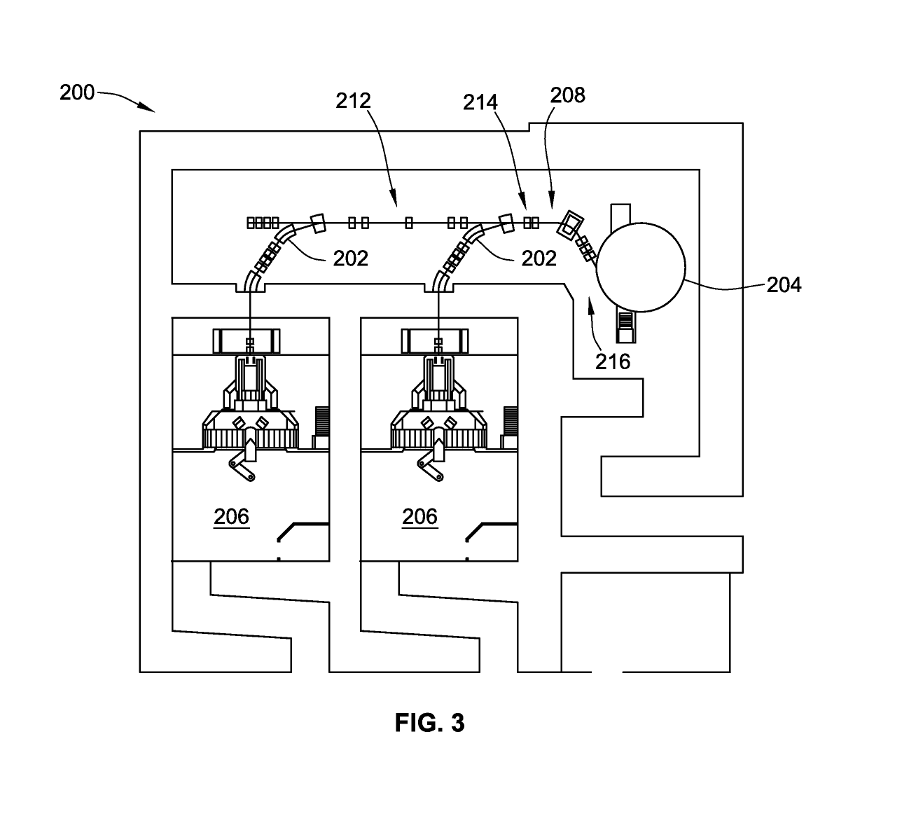

FIG. 3 is a top view of a particle beam transport system 200 that uses fixed-magnetic-field-strength permanent magnets 202 for beam transport, constructed in accordance with an embodiment of the invention. The beam from a particle accelerator 204 is extracted at fixed energy, and transported at fixed energy along a common beam line 208. In a particular embodiment of the particle beam transport system 200, the fixed-magnetic-field-strength permanent magnets 202, used in beam delivery, are permanent quadrupole magnets, and could weigh as little as two hundred pounds. From the common beam line 208, the beam is then deflected into separate energy selection systems for each of the treatment rooms 206 receiving.

As shown in the embodiment of FIG. 3, the particle beam transport system 200 includes a separate beam energy modification system installed at the entry to each treatment room 206. In this embodiment, the beam transported in the main beam line 208 is of fixed energy, and fixed magnetic-field-strength permanent magnets 202 are used. This allows a constant energy proton beam from the accelerator 204 to be first transported along the main beam line 208 and the various energies required for a particular treatment room 206 are then prepared after the beam has been deflected towards that particular treatment room 206. Permanent quadrupole magnets, dipole magnets, or some other types of multi-pole magnets may be used in embodiments of the particle beam transport system 200 for transporting and manipulating charged particle beams. In certain embodiments, the fixed-magnetic-field-strength permanent magnets 202 can be made from samarium cobalt metal or from a strontium ferrite ceramic material, or other suitable materials. Rare earth elements are often used for permanent magnets where high magnetic field strength is required.

As stated above, use of high-magnetic-field-strength permanent magnet technology in beam transport systems, in accordance with an embodiment of the present invention, reduces the capital costs and operating costs of proton radiation therapy systems. Moreover, permanent magnets require no power supply or cooling water utilities, and thus greatly simplify installation and reduce operating costs when used in proton particle beam transport systems 200 such as illustrated in FIG. 3. Also, permanent magnets exhibit long-term stability when used for beam transport making their use advantageous for application in proton radiation therapy where such stability is desirable.

In at least one embodiment of the present invention, the proton beam enters the permanent magnet beam transport line 212 along the axis of a sequence of quadrupole magnets and within a certain percentage of the design energy. To compensate for minor variations in the beam direction and to verify that the beam energy stays constant at the entry to the permanent magnet beam transport line 212, a beam energy and direction matching system 216 is used in one embodiment. To do so, the beam energy and direction matching system 216 is positioned between the exit from the accelerator 204 and the start of the permanent magnet quadrupole section as shown in FIG. 3.

To change the trajectory of the beam, permanent dipole magnets, for example, may be used. These magnets have a homogeneous field orientated perpendicular to the beam trajectory. The angle of bend is proportional to the strength of the magnetic field. Typically, several dipole magnets are required to bend the fixed-energy beam such that it enters the treatment room at the proper angle and position for treatment. Permanent magnet dipoles and/or quadrupoles may be constructed from steel pole pieces with permanent magnet material arranged on the top, bottom, and sides of the poles. The steel poles shape the field while the permanent magnets provide a magnetic field to direct the beam. Permanent dipole (and quadrupole) magnets, for example, generally weigh much less than electro-magnets and do not require high-current power supplies or cooling water, thereby reducing the complexity and increasing the reliability of a beam line using such permanent magnets. They are also more stable, alleviating the need for varying of the current from power supplies.

Typically, to maximize the efficiency, a treatment center will have several treatment rooms 206 sharing beam from one accelerator 204. During operation, one treatment room 206 will be in the process of preparing a patient, while another treatment room 206 is used to treat a second patient, and in a third the patient will be leaving the treatment room 206. To accomplish this, the beam will be directed from the accelerator 204 to different beam lines.

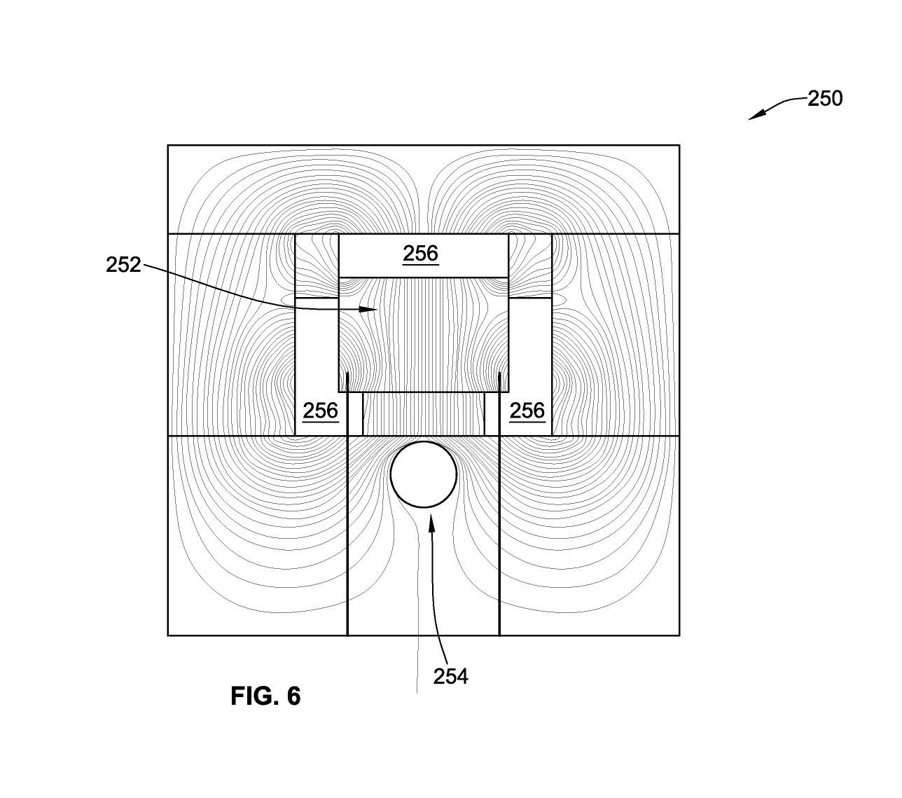

In particular embodiments, this is accomplished through the use of a fast dipole system, also referred to as a “kicker system”, and a permanent magnet Lambertson, or Lambertson magnet. Alternate embodiments may employ permanent magnets other than Lambertson magnets. As shown in the schematic illustration of FIG. 6, the Lambertson magnet 250 is a dipole magnet with both a magnetic field region 252 and a field-free region 254. Lambertson magnets 250 are constructed in a similar manner as dipole magnets. For example, Lambertson magnets 250 may include steel poles 256 with permanent magnet material attached to the top, bottom and sides. In addition in the flux return there is the field-free region 254 represented, in FIG. 6, as a hole in which there is very little magnetic field.

When the beam is not being directed to a treatment room 206, the Kicker magnet will be off and the beam will travel through the field-free region 254 undisturbed. When beam is required for treatment, the Kicker magnet will pulse, sending the beam through the field region of the Lambertson magnet 250 thereby bending the beam into the proper channel and delivering the beam to the patient.

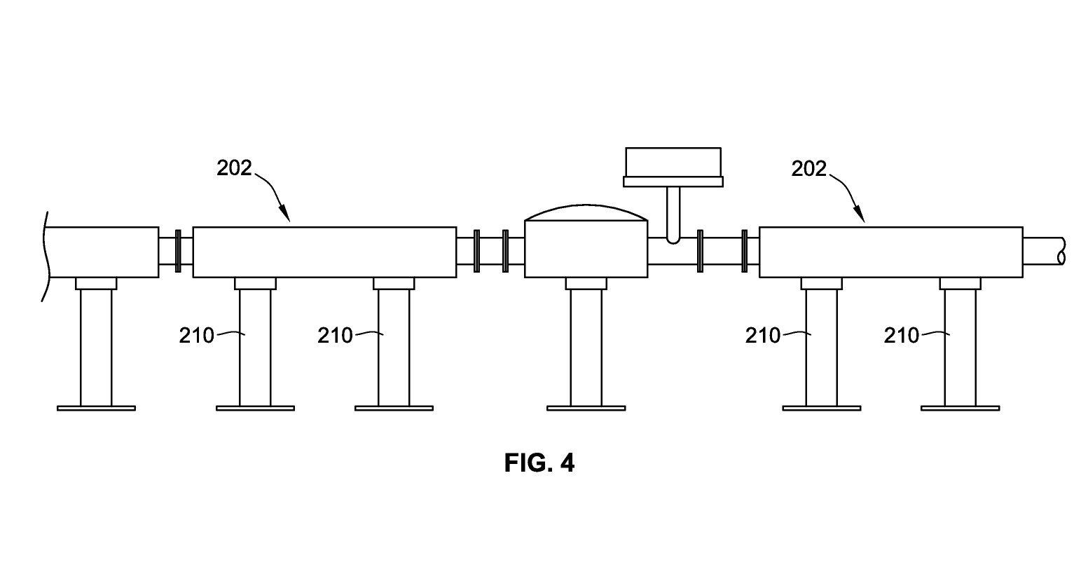

As can be seen from the plan view illustration in FIG. 4, in particular embodiments of the invention, the fixed-magnetic-field-strength permanent magnets 202 can be pre-mounted on stands 210 and aligned during manufacture, but before installation, for example, at a proton therapy treatment center, thus greatly reducing the installation time at the treatment center.

As will now be apparent to those skilled in the art, embodiments of the present invention provide a particle beam transport system 200 used in treating a patient by means of particle radiation therapy wherein a beam of particles exiting from an accelerator 204 is transported at fixed energy using a system of fixed-magnetic-field permanent magnets 202. The constant energy beam can be directed and modified independently for treatment of patients in one or more treatment rooms 206. Preferably, several fixed-magnetic-field permanent magnets 202 are mounted on stands 210 and aligned on a common magnet axis before installation.

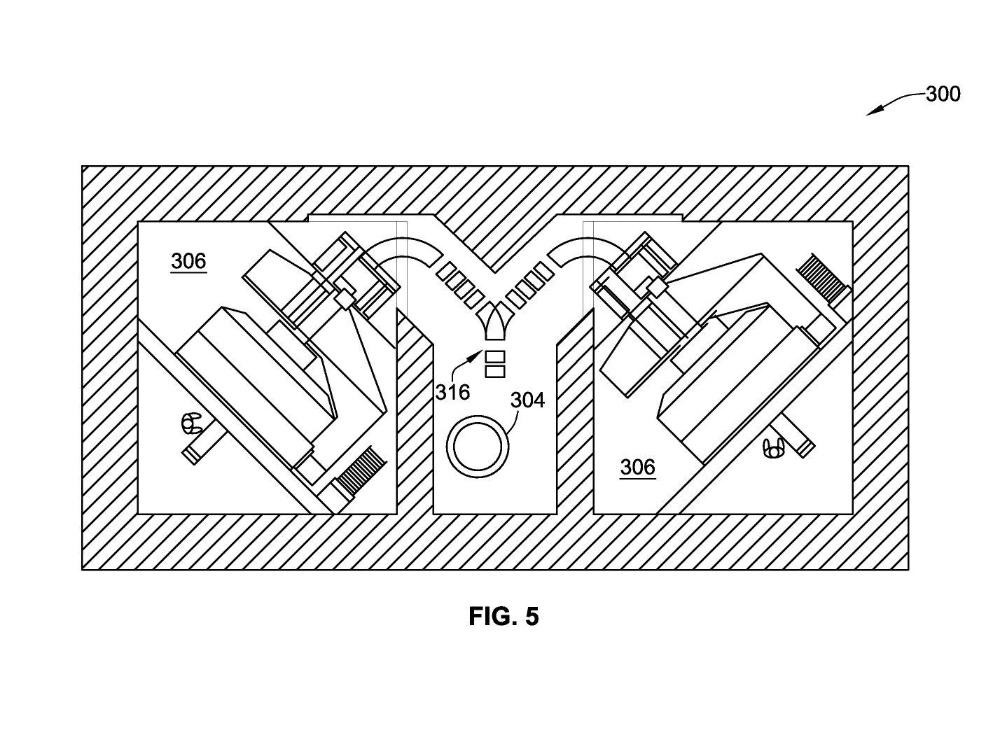

If the site where a particle therapy system is to be installed is limited in size or be of complex configuration, the particle beam transport system 200 may be installed in such space due to its inherent flexibility. One example of such a complex configuration is shown in the particle beam transport system 300 illustrated in FIG. 5. In this embodiment, the accelerator 304 is positioned between two rooms 306. Shortly after exiting the accelerator 304, the particle beam is separated into two beams, possibly having different energies, traveling in opposite directions. In some manifestations the accelerator 204 may be at a different elevation than the treatment rooms 206.

In particular embodiments, a matching section 216, 316 is imposed as beam exits the particle accelerator 204, 304. This matching section 216, 316 may include diagnostic elements and feedback systems that verify and vary the beam energy exiting the accelerator 204, 304 and if necessary modify the beam until it attains some pre-specified energy value. In particular embodiments of the invention, rather than the fixed-magnetic-field-strength systems described above, the matching section 216, 316 is made using variable magnetic-field dipole and quadrupole electro-magnets. The matching section 216, 316 automatically varies and directs beam along the line on which the permanent magnet quadrupole elements are positioned.

The particle beam transport system of the present invention includes, in certain embodiments, one or more permanent quadrupole magnets. In other embodiments, the particle beam transport system includes one or more permanent dipole magnets. In still another embodiment, the particle beam transport system includes one or more permanent magnets Lambertson. In at least one embodiment the fixed-magnetic-field permanent magnets 202 are made out of strontium ferrite material. In another embodiment the permanent magnets 202 are made out of samarium cobalt or neodymium iron boron materials and weigh less than three hundred pounds.

When a fixed-energy beam is transported to each treatment room 206, 306 significant advantages can be achieved by use of fixed-magnetic-field-strength permanent magnets 202 instead of electromagnets, namely, stability of beam position, and simplicity of operation and installation. Additionally, transport of the proton beam using permanent magnets means that operation of the magnets will not require and intervention by accelerator technical staff. Because the particle beam transport system 200, 300 can be constructed more inexpensively than conventional particle beam systems 100, have a smaller footprint, and be lighter in weight than conventional systems 100, the particle beam transport system 200, 300 can be installed in hospitals and in other sites that could not afford a conventional system, or whose facilities preclude the use of large electromagnets in beam transport.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A particle beam transport system for use in treating a patient by means of particle radiation therapy comprising a particle beam generator that provides a beam of particle, wherein the beam of particles exits from an accelerator and is transported at fixed energy in arbitrary directions using a system of fixed-magnetic-field permanent magnets.

2. The particle beam transport system of claim 1, wherein the permanent magnets provide high magnetic field strength by use of rare earth elements.

3. The particle beam transport system of claim 1, wherein the beam has constant energy, the beam being directed independently using a permanent magnet Lambertson for treatment of patients in one or more treatment rooms.

4. The particle beam transport system of claim 1, wherein a matching section is imposed as the beam exits the particle accelerator, the matching system having diagnostic elements and feedback control systems that evaluate the beam energy exiting the accelerator and, if necessary, automatically modifies its properties until it attains some pre-specified energy and direction.

5. The particle beam transport system of claim 4, wherein the matching section includes variable-magnetic-field dipole and quadrupole electro-magnets.

6. The particle beam transport system of claim 4, wherein the matching section automatically varies and directs the beam along a line on which permanent quadrupole magnets are positioned.

7. The particle beam transport system of claim 1, where the system of fixed-magnetic-field permanent magnets includes one or more permanent quadrupole magnets.

8. The particle beam transport system of claim 1, wherein the system of fixed-magnetic-field permanent magnets includes one or more permanent dipole magnets.

9. The particle beam transport system of claim 1, wherein the system of fixed-magnetic-field permanent magnets includes one or more permanent Kicker magnets.

10. The particle beam transport system of claim 1, wherein the system of fixed-magnetic-field permanent magnets comprises an array of magnets that can be arranged in multiple configurations.

11. The particle beam transport system of claim 1, further comprising one or more ambient temperature electro-magnets in addition to permanent magnets.

12. The particle beam transport system of claim 1, wherein the permanent magnets are made from one of the rare earth materials, strontium ferrite and neodymium iron boron.

13. The particle beam transport system of claim 1, wherein the permanent magnets are made from a rare earth material, and, collectively, weigh less than 300 lbs.

14. The particle beam transport system of claim 1, wherein several permanent magnets are mounted on stands and aligned on a common mechanical device before installation.
